(19) United States
(12) Patent Application Publication
(10) Pub. No.: US 2023/0419587 A1
(43) Pub. Date: Dec. 28, 2023

(54) MULTI-CHIP BASED RAY TRACING DEVICE AND METHOD USING FRAME PARTITIONING

(71) Applicant: INDUSTRY ACADEMY COOPERATION FOUNDATION OF SEJONG UNIVERSITY, Seoul (KR)

(72) Inventors: Woo Chan PARK, Seoul (KR); Jin Young LEE, Seoul (KR)

(73) Assignee: INDUSTRY ACADEMY COOPERATION FOUNDATION OF SEJONG UNIVERSITY, Seoul (KR)

(21) Appl. No.: 18/034,842

(22) PCT Filed: Dec. 1, 2020
(86) PCT No.: PCT/KR2020/017369

§ 371 Date: May 1, 2023

(30) Foreign Application Priority Data
Oct. 30, 2020 (KR) 10-2020-0143658

(51) Int. Cl. G06T 15/06; G06T 17/00; G06T 1/60

(52) U.S. Cl. CPC G06T 15/06; G06T 17/005; G06T 1/60

(57) ABSTRACT

There are provided a multi-chip based ray tracing device and a method using frame partitioning. The multi-chip based ray tracing device includes a system memory storing geometry data and an acceleration structure (AS) for scene generation; a plurality of ray tracing cores performing independent ray tracing for individual frames based on the geometry data and the acceleration structure; and a central processing unit executing and managing a ray tracing application and a scene manager and delivering the geometry data and the acceleration structure to the plurality of ray tracing cores.

### CROSS REFERENCE TO PRIOR APPLICATIONS

This application is a National Stage Patent Application of PCT International Patent Application No. PCT/KR2020/017369 (filed on Dec. 1, 2020) under 35 U.S.C. § 371, which claims priority to Korean Patent Application No. 10-2020-0143658 (filed on Oct. 30, 2020), which are all hereby incorporated by reference in their entirety.

### ACKNOWLEDGEMENT

National research and development project that supported this invention
Project unique number: 1711103244
Project number: 2016-0-00204-005
Department: Ministry of Science and ICT
Project management (Professional) Institute: Institute of Information & Communication Technology Planning & Evaluation
Research Project Name: ICT Convergence Industry Source Technology Development (R&D)
Research Title: Development of Mobile GPU Hardware for Hyper-realistic Real-time Virtual Reality
Contribution rate: 1/1
Name of project performing organization: Industry Academy Cooperation Foundation of Sejong University
Research period: 2020.01.01˜2021.12.31

### BACKGROUND

The present disclosure relates to a three-dimensional (3D) graphics processing technology. More particularly, the present disclosure relates to a multi-chip based ray tracing device and method using frame partitioning capable of graphics processing with improved performance using a plurality of chips performing ray tracing independently.

3D graphics technology is a branch of graphics technology that uses a 3D representation of geometric data stored in a computing device and is widely used today in various industries, including media and game industries. In general, 3D graphics technology requires a separate high-performance graphics processor due to a large amount of computation.

Along with advances in the processors, research has been underway to develop ray tracing technology that may generate photo-realistic 3D graphics.

Ray tracing technology relates to a rendering method based on global illumination. Ray tracing technology generates realistic 3D images by providing reflection, refraction, and shadow effects in a natural manner by simulating the effect of light reflected or refracted from another object on the image of a target object.

### PRIOR ART REFERENCES

### Patents

Korea laid-open patent 10-2015-0039493 (2015 Apr. 10)

### SUMMARY

An object according to one embodiment of the present disclosure is to provide a multi-chip based ray tracing device and method using frame partitioning capable of graphics processing with enhanced performance using a plurality of chips performing ray tracing independently.

Another object according to one embodiment of the present disclosure is to provide a multi-chip based ray tracing device and method using frame partitioning capable of providing performance enhancement related to ray tracing in proportion to the number of chips used in a multi-chip based system implemented to include a tree build unit independently for each chip.

A multi-chip based ray tracing device using frame partitioning according to the embodiments comprises a system memory storing geometry data and an acceleration structure (AS) for scene generation; a plurality of ray tracing cores performing independent ray tracing for individual frames based on the geometry data and the acceleration structure; and a central processing unit executing and managing a ray tracing application and a scene manager and delivering the geometry data and the acceleration structure to the plurality of ray tracing cores.

The system memory may include a primitive static scene (PSS) area storing PSSs, a primitive dynamic scene (PDS) area storing PDSs, and AS areas, each of which stores a static acceleration structure and dynamic acceleration structures.

Each of the plurality of ray tracing cores may include a bus interface unit processing data transmission and reception; a tree build unit (TBU) constructing an acceleration structure (AS); a ray tracing unit (RTU) performing ray tracing based on the AS; and a local memory temporarily storing the geometry data and the AS for the ray tracing.

The ray tracing device may further include a frame unit arranging and outputting frames received from the plurality of ray tracing cores in a predetermined order.

The frame unit may include a plurality of frame buffers assigned to each of the plurality of ray tracing cores and storing the frames in the order in which the frames are processed; and a frame queue storing frames received from the plurality of frame buffers according to frame numbers regardless of the processing order.

Each of the plurality of frame buffers may have the same size, and the size of the frame queue may be determined according to the number and size of frame buffers.

The frame unit may store a specific frame stored in the frame buffer into the frame queue by mapping the corresponding frame number to a queue index.

The frame unit may operate by reading a current draw number; comparing the draw number with frame numbers of frames stored in the frame queue; if the draw number is equal to the frame number, outputting the corresponding frame; increasing the draw number by 1 when the outputting is successful; and repeating the above process until the frame queue becomes empty.

A multi-chip based ray tracing method using frame partitioning according to embodiments comprises determining a total number of a plurality of ray tracing cores for performing ray tracing on a plurality of frames constituting a specific scene; assigning the plurality of frames to each of the plurality of ray tracing cores by partitioning the plurality of frames in frame units; transmitting geometry data of a system memory to each of the plurality of ray tracing cores; determining whether ray tracing is completed in units of frames for each of the plurality of ray tracing cores; when a specific ray tracing core completes ray tracing, storing the corresponding frame in the corresponding frame buffer; storing the corresponding frame in a frame queue; and outputting frames of the frame queue sequentially.

The determining of the total number of the plurality of ray tracing cores may include initializing a draw number, and the outputting may include outputting a frame having the same frame number as a current draw number from the frame queue.

The outputting may include increasing the current draw number by 1 when the outputting is successful.

The assigning of the plurality of frames into each of the plurality of ray tracing cores may include assigning a frame number to an assigned frame, wherein the frame number is set for each ray tracing core and set at an interval equal to the total number of frames with respect to a previous frame number.

When the frame number is larger than the total number of the plurality of frames, rendering of the specific scene may be terminated.

The present disclosure may provide the following effects. However, since it is not meant that a specific embodiment has to provide all of or only the following effects, the technical scope of the present disclosure should not be regarded as being limited by the specific embodiment.

A multi-chip based ray tracing device and method using frame partitioning according to one embodiment of the present disclosure may perform graphics processing with enhanced performance using a plurality of chips performing ray tracing independently.

A multi-chip based ray tracing device and method using frame partitioning according to one embodiment of the present disclosure may provide performance enhancement related to ray tracing in proportion to the number of chips used in a multi-chip based system implemented to include a tree build unit independently for each chip.

### BRIEF DESCRIPTION OF THE DRAWINGS

FIG. 1 shows one embodiment of a ray tracing process.

FIG. 2 shows one embodiment of a KD tree as an acceleration structure used in a ray tracing process.

FIG. 3 illustrates a multi-chip ray tracing system using screen partitioning.

FIG. 4 illustrates a multi-chip ray tracing system using frame partitioning according to the present disclosure.

FIG. 5 illustrates a frame arrangement operation according to display order.

FIG. 6 is a flow diagram illustrating an operational process of a multi-chip ray tracing method using frame partitioning according to the present disclosure.

### DETAILED DESCRIPTION

Since the description of the present disclosure is merely an embodiment for structural or functional explanation, the scope of the present disclosure should not be construed as being limited by the embodiments described in the text. That is, since the embodiments may be variously modified and may have various forms, the scope of the present disclosure should be construed as including equivalents capable of realizing the technical idea. In addition, a specific embodiment is not construed as including all the objects or effects presented in the present disclosure or only the effects, and therefore the scope of the present disclosure should not be understood as being limited thereto.

On the other hand, the meaning of the terms described in the present application should be understood as follows.

Terms such as “first” and “second” are intended to distinguish one component from another component, and the scope of the present disclosure should not be limited by these terms. For example, a first component may be named a second component and the second component may also be similarly named the first component.

It is to be understood that when one element is referred to as being “connected to” another element, it may be connected directly to or coupled directly to another element or be connected to another element, having the other element intervening therebetween. On the other hand, it is to be understood that when one element is referred to as being “connected directly to” another element, it may be connected to or coupled to another element without the other element intervening therebetween. Meanwhile, other expressions describing a relationship between components, that is, “between,” “directly between,” “neighboring to,” “directly neighboring to,” and the like, should be similarly interpreted.

It should be understood that the singular expression includes the plural expression unless the context clearly indicates otherwise, and it will be further understood that the terms “comprises” or “have” used in this specification, specify the presence of stated features, numerals, steps, operations, components, parts, or a combination thereof, but do not preclude the presence or addition of one or more other features, numerals, steps, operations, components, parts, or a combination thereof.

Identification symbols (for example, a, b, and c) for individual steps are used for the convenience of description. The identification symbols are not intended to describe an operation order of the steps. Therefore, unless otherwise explicitly indicated in the context of the description, the steps may be executed differently from the stated order. In other words, the respective steps may be performed in the same order as stated in the description, actually performed simultaneously, or performed in reverse order.

The present disclosure may be implemented in the form of program code in a computer-readable recording medium. A computer-readable recording medium includes all kinds of recording devices storing data that a computer system may read. Examples of a computer-readable recording medium include a ROM, a RAM, a CD-ROM, a magnetic tape, a floppy disk, and an optical data storage device. Also, the computer-readable recording medium may be distributed over computer systems connected through a network so that computer-readable code may be stored and executed in a distributed manner.

Unless defined otherwise, all the terms used in the present disclosure provide the same meaning as understood generally by those skilled in the art to which the present disclosure belongs. Those terms defined in ordinary dictionaries should be interpreted to have the same meaning as conveyed in the context of related technology. Unless otherwise defined explicitly in the present disclosure, those terms should not be interpreted to have ideal or excessively formal meaning.

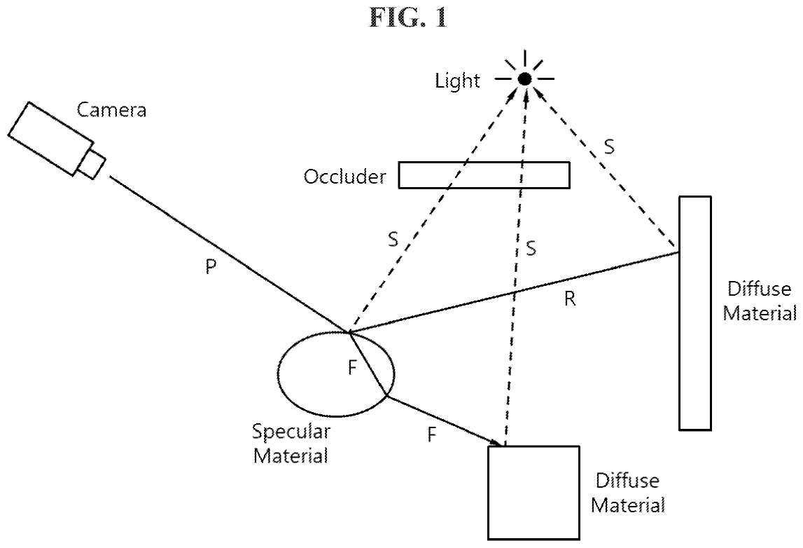

FIG. 1 shows one embodiment of a ray tracing process.

Referring to FIG. 1, a ray tracing method performed in a ray tracing device may correspond to a rendering method according to global illumination. The use of global illumination-based rendering may imply that light reflected or refracted from other objects also affects the image of a target object. As a result, realistic 3D images may be generated since reflection, refraction, and shadow effects are realized in a natural manner.

The ray tracing device may first generate a primary ray P from a camera position per pixel and perform calculations to find an object that intersects the ray. The ray tracing device may generate a reflection ray R for a reflection effect or a refraction ray F for a refraction effect at the intersection point where the ray and the object meet if the object hit by the ray has a reflection or refraction property; for a shadow effect, the ray tracing device may generate a shadow ray S in the direction of light.

Here, if the shadow ray directed to the corresponding light and an object meet, a shadow is created; otherwise, no shadow is created. The reflected ray and the refracted ray are called secondary rays, and the ray tracing device may perform calculations for each ray to find an object that intersects the ray. The ray tracing device may perform the above process recursively.

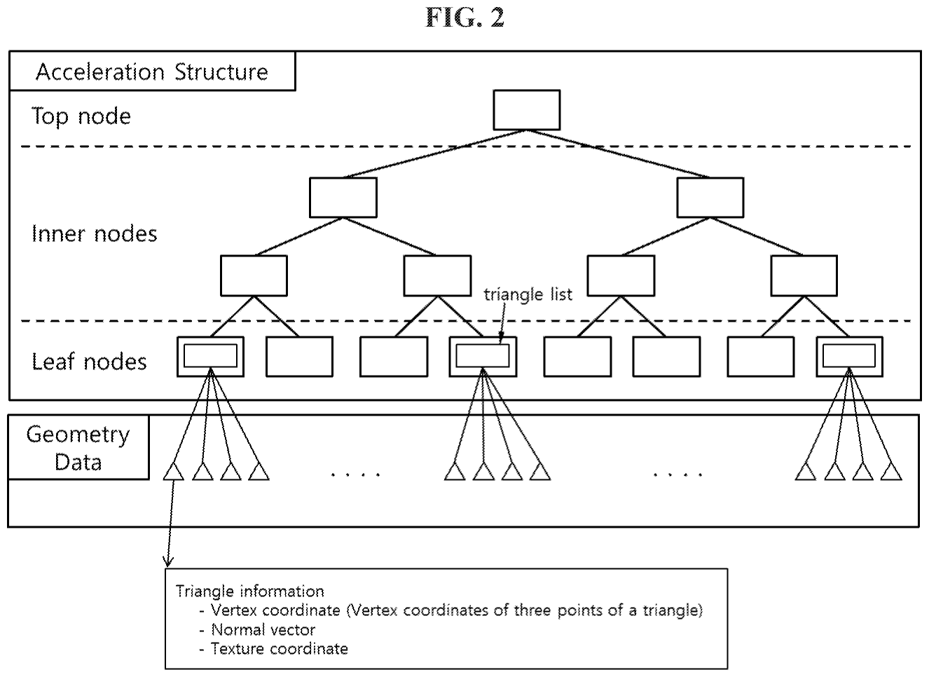

FIG. 2 shows one embodiment of a KD tree as an acceleration structure used in a ray tracing process.

Referring to FIG. 2, to perform ray tracing, an acceleration structure (AS), such as a KD tree or a Bounding Volume Hierarchy (BVH), generated based on the entire geometry data (consisting of the coordinates of triangles) is essential. Therefore, it is necessary to build an AS before performing ray tracing. Since building such an acceleration structure requires a lot of computation, it may take considerable time.

FIG. 2 illustrates the overall structure of a KD tree. The KD tree may correspond to a binary tree having a hierarchical structure for a partitioned space. A KD tree may consist of inner nodes (including the top node) and leaf nodes, and a leaf node may correspond to a space containing objects that intersect with the corresponding node. In other words, the KD tree is a spatial partitioning tree and may correspond to one of the spatial partitioning structures.

On the other hand, an inner node may occupy a bounding box-based spatial area, and the corresponding spatial area may be split into two areas and assigned to two lower nodes. As a result, an inner node may consist of a splitting plane and a sub-tree of two areas partitioned by the splitting plane, and a leaf node may contain only a series of triangles. For example, a leaf node may include a triangle list for pointing to at least one triangle information included in geometric data; the triangle information may include vertex coordinates for three points of the triangle, normal vectors, and/or texture coordinates. If triangle information in the geometric data is implemented as an array, the triangle list in a leaf node may correspond to the array index.

On the other hand, the space-partitioning position p may correspond to the point where the cost (the number of node visits, the number of times for calculating whether a ray intersects a triangle, and so on) to find a triangle that hits an arbitrary ray is minimized; the most popular method used to find the corresponding position p may be the surface area heuristic (SAH).

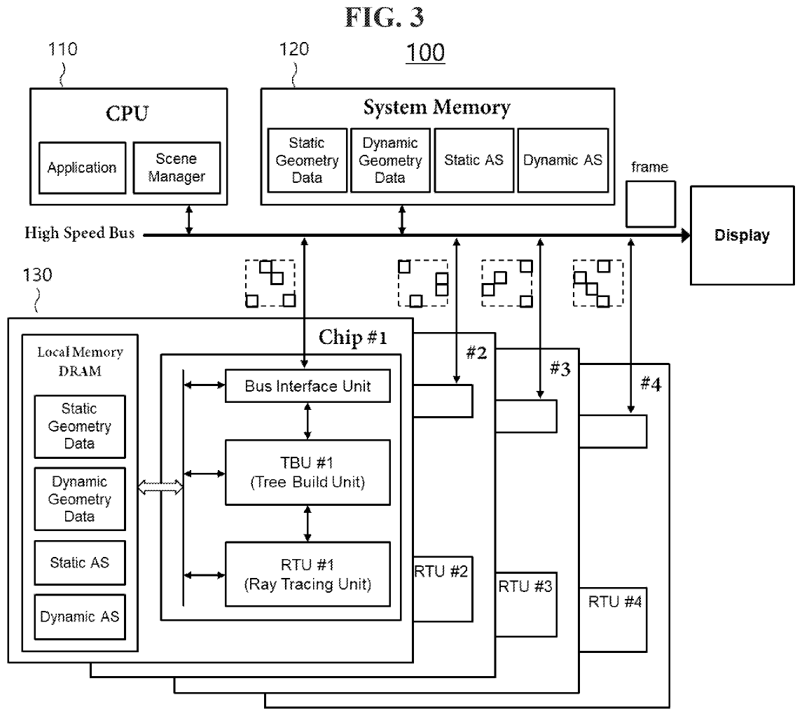

FIG. 3 illustrates a multi-chip ray tracing system using screen partitioning.

Referring to FIG. 3, the multi-chip ray tracing system 100 using screen partitioning may perform scene rendering using n multi-chips (ASICs or FPGAs). The multi-chip ray tracing system 100 using screen partitioning may comprise a central processing unit (CPU) 110, a system memory 120, and multi-chips. The CPU 110 may execute and manage a ray tracing application and a scene manager. Also, the CPU 110 may perform the role of delivering geometry data and AS data to each of the multi-chips 130.

The multi-chips 130 may comprise a bus interface unit, a ray tracing unit (RTU), and a local memory for received geometry data and acceleration structure data. In particular, one of the multi-chips (chip #1 in FIG. 3) may partition the screen and distribute the partitioned screen areas and may include a tree build unit (TBU) for generating a kd-tree.

An operational process performed in the multi-chip ray tracing system 100 using screen partitioning may be as follows. The tree build unit (TBU) of chip #1 may receive geometry data for a frame to be rendered and construct a kd-tree as a spatial partitioning structure.

When the construction of a kd-tree is completed in chip #1 of the multi-chip ray tracing system 100 using screen partitioning, kd-tree information may be transmitted to ray tracing units (RTUs) #1 to #n, respectively, and each ray tracing unit (RTU) may perform ray tracing based on the kd-tree information. Here, chip #1 may serve as a load master that assigns a ray tracing area to the ray tracing unit (RTU) of each chip, partition a frame to be rendered into frame areas composed of blocks of k*k pixels (e.g., 8*8), and distribute the blocks to each chip. The ray tracing unit (RTU) of each chip may perform ray tracing on the assigned area, and a generated color result may be stored in the frame buffer of chip #1 through the memory controller. Finally, each chip may perform ray tracing on an area corresponding to 1/n of a frame.

In other words, the screen partitioning may correspond to a method that partitions a single frame into a group of areas for which a plurality of ray tracing units (RTUs) perform rendering, respectively. Here, since all ray tracing units (RTUs) require kd-tree information for the corresponding frame, large-scale data transmission may occur. It is so because a chip equipped with a tree build unit (TBU) has to construct a kd-tree for the corresponding frame and transmit the constructed kd-tree to all ray tracing units (RTUs).

The amount of data transmission may increase as the number of chips used in the system increases. If the number of chips is n, data transmission for a kd-tree may occur n times per frame. As a result, a total of n*m data transmission may occur for a scene composed of m frames.

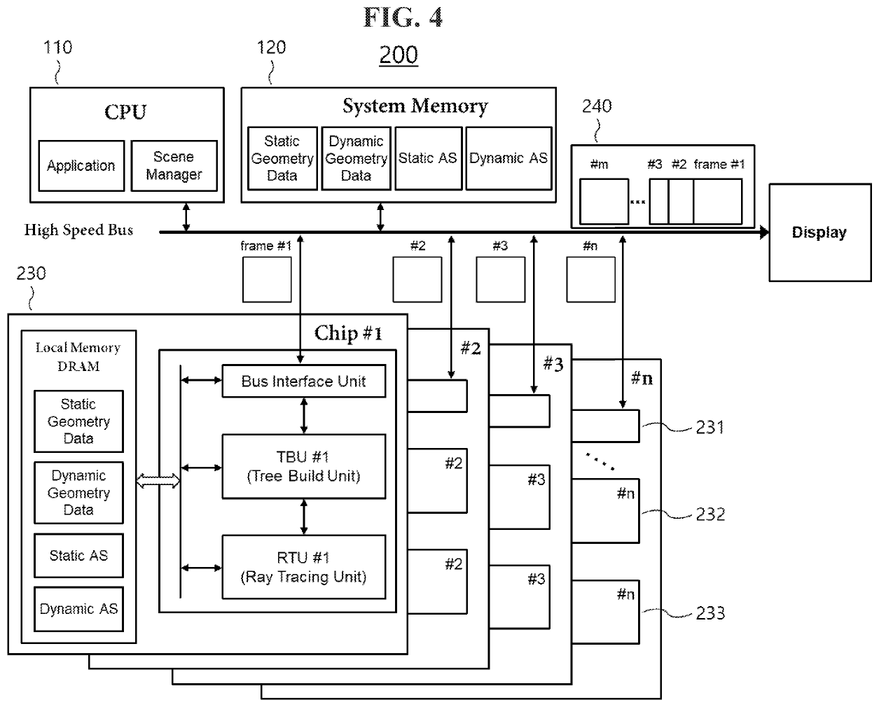

FIG. 4 illustrates a multi-chip ray tracing system using frame partitioning according to the present disclosure.

Referring to FIG. 4, a multi-chip ray tracing system 200 using frame partitioning may include a central processing unit (CPU) 110 and a system memory 120 in the same manner as the multi-chip ray tracing system 100 using screen partitioning. The CPU 110 may execute and manage a ray tracing application and a scene manager and may deliver geometry data and AS data to a plurality of ray tracing cores 230. The system memory 120 may store geometry data and an AS for scene generation.

In one embodiment, the system memory 120 may include a primitive static scene (PSS) area storing PSSs, a primitive dynamic scene (PDS) area storing PDSs, and AS areas, each of which stores static and dynamic ASs.

In one embodiment, the multi-chip ray tracing system 200 using frame partitioning may include a plurality of ray tracing cores 230, each of which performs independent ray tracing for individual frames based on the geometry data and acceleration structure.

In one embodiment, each of a plurality of ray tracing cores 230 may include a bus interface unit 231 processing data transmission and reception, a tree build unit (TBU) 232 constructing an acceleration structure (AS), a ray tracing unit (RTU) 233 performing ray tracing based on the AS, and a local memory temporarily storing the geometry data and the AS for ray tracing.

More specifically, the tree build unit (TBU) 232 may perform an operation of constructing an acceleration structure (AS) as a spatial partitioning structure. For example, the tree build unit 232 may generate an acceleration structure (AS), such as the bounding volume hierarchy (BVH) and the K-Dimensional (KD) tree, based on the geometry data stored on the system memory 120 and store the generated AS on a local memory.

More specifically, the tree build unit 232 may generate an acceleration structure related to static and dynamic scenes required for a ray tracing process as an application such as a 3D game engine is run. Here, in the case of a static scene, a static AS may be generated through a single tree build when the 3D application is run, while a dynamic AS may be generated as a tree build is performed for each frame since primitive information changes for each frame in the case of a dynamic scene. The static and dynamic ASs generated by the tree build unit (TBU) may be stored in the local memory of the respective ray tracing cores and used for a subsequent ray tracing process.

The ray tracing unit (RTU) 233 may perform ray tracing based on spatial partitioning structure, namely, acceleration structure. More specifically, the ray tracing unit (RTU) 233 may perform ray tracing using static and dynamic ASs generated by the tree build unit (TBU) 232, and the static and dynamic ASs may be stored in the local memory, respectively.

In the multi-chip ray tracing system 200 using frame partitioning according to the present disclosure, unlike the screen partitioning scheme of FIG. 3, all chips, namely, the ray tracing cores 230, may be implemented to include an independent tree build unit (TBU), respectively. In other words, the multi-chip ray tracing system 200 using frame partitioning may operate so that a ray tracing core corresponding to one chip performs rendering of one frame independently. Therefore, since all chips are equipped with an RTU and a TBU, construction of a kd-tree and ray tracing may be performed independently for an assigned frame; moreover, different from the screen partitioning scheme, additional data transmission may not be required, such as transmitting the kd-tree information to a chip without a TBU or transmitting a resultant value obtained from ray tracing by the RTU to a frame buffer of a specific chip (chip #1 in FIG. 3).

Also, when the number of chips used in the system increases, the screen partitioning scheme may increase the total amount of data transmission, whereas the frame partitioning scheme may maintain the total amount of data transmission to a previous level. In other words, in the frame partitioning scheme, when the number of chips used in the system is n, the total amount of data transmission for a scene composed of m frames may always be maintained constant at m.

On the other hand, the screen partitioning scheme enhances rendering performance as the number of RTUs increases, while, in the case of kd-tree construction, parallelization may be very difficult due to the algorithmic structure, and performance enhancement may not be achieved even if the number of TBUs increases. In other words, in the screen partitioning scheme of FIG. 3, a plurality of chips may generate one frame, and as the number of chips increases, the number of RTUs increases, leading to enhancement of rendering performance, while TBU performance may remain unchanged. As a result, the performance difference between the RTU and the TBU may grow, which may act as a limitation in improving the performance of the entire system.

On the other hand, in the frame partitioning scheme of FIG. 4, each of a plurality of chips generates a frame, and each chip may be implemented to include an RTU and a TBU. In other words, as the number of chips increases, the numbers of RTUs and TBUs increase, and the number of frames simultaneously generated increases proportionally. In the frame partitioning scheme, as the number of chips installed in the system grows, performance enhancement may be expected in proportion to the amount of increase.

In one embodiment, the multi-chip ray tracing system 200 using frame partitioning may be implemented to further include a frame unit 240 that arranges and outputs frames received from a plurality of ray tracing cores 230 in a predetermined order. The frame unit 240 may correspond to a logical configuration of the multi-chip ray tracing system 200 using frame partitioning and may be implemented as an independent module performing the corresponding operation or a logical set of functions performed by other modules. Accordingly, although FIG. 4 illustrates the frame unit 240 as an independent unit, it is not necessarily limited thereto, and the frame unit 240 may be functionally distributed to be embodied as an internal operation of other units or a linked operation between other units.

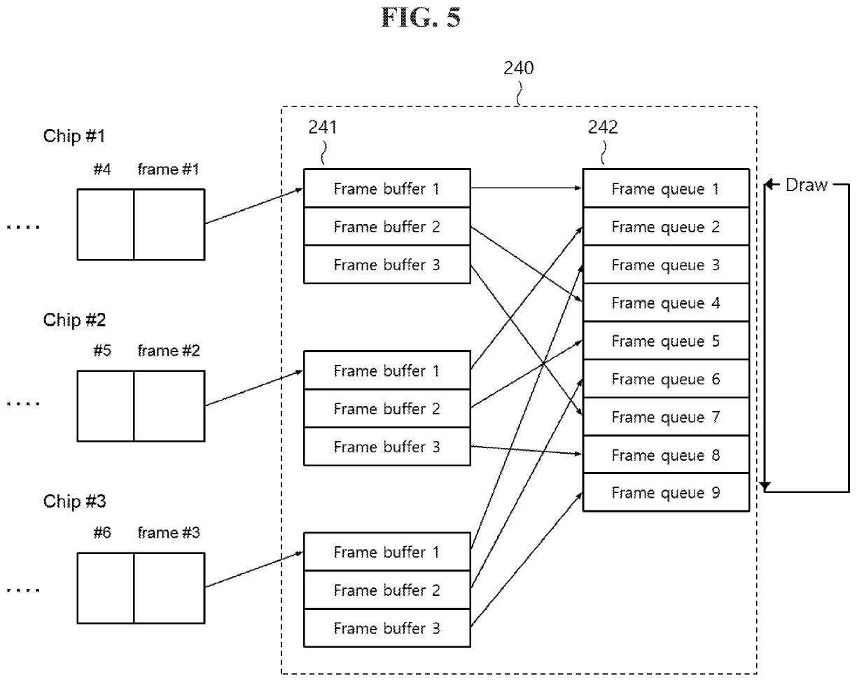

FIG. 5 illustrates a frame arrangement operation according to display order.

Referring to FIG. 5, a multi-chip ray tracing system 200 using frame partitioning may arrange and output frames received from a plurality of ray tracing cores 230 through a frame unit 240 in a predetermined order.

In one embodiment, the frame unit 240 may include a plurality of frame buffers 241 assigned respectively to a plurality of ray tracing cores 230 and storing frames according to a processing order and a frame queue 242 storing frames received from the plurality of frame buffers 241 according to frame numbers regardless of the processing order. The frame partitioning scheme may correspond to a method that generates a large number of frames simultaneously and displays the generated frames on a screen. At this time, since the order of completing the generation of a frame does not necessarily coincide with the order of displaying the frame, the display order may not be in sequence if generated frames are directly stored in the frame buffer 241 without post-processing. To prevent any disruption in the display order, it is required to match the order of frames stored in the frame buffer 241 with the display order. In other words, the frame unit 240 may be implemented by logically including independent frame buffers 241 in each of the plurality of ray tracing cores 230 with the frame queue 242 operating in conjunction with the corresponding buffers.

In one embodiment, a plurality of frame buffers 241 are formed to have the same size, and the size of the frame queue 242 may be determined according to the number and size of the frame buffers 241. For example, in the case of FIG. 5, the frame buffers 241 of each chip may be composed of three buffers, and the size of the frame queue 242 operating in conjunction with the frame buffers 241 of each chip may be determined to be 9 in proportion to the number (e.g., 3) and size (e.g., 3) of frame buffers 241. In other words, the frame unit 240 may arrange frames processed by various chips through the frame buffers 241 formed in the respective chips and the frame queue 242 operating in conjunction with the frame buffers 241 according to an actual order.

In one embodiment, the frame unit 240 may store a specific frame stored in the frame buffer 241 into the frame queue 242 by mapping the corresponding frame number to a queue index. Here, the frame number may coincide with the display order, a chip number may determine an initial value, and the chip number may correspond to an identification number assigned to each ray tracing core. For example, Chip #1 may generate frame #1, Chip #2 may generate frame #2, and Chip #3 may generate frame #3. Subsequently, the frame number of a frame assigned to each chip may be calculated by adding the number of chips used in the system to the frame number of the first assigned frame.

Also, after a frame assigned to each chip is generated, the generated frame may be stored in the frame buffer 241 one after another. For example, frame #1 may be stored in the frame buffer 1 of Chip #1; subsequently, frame # (1 (chip number)+n (a total number of chips)) may be stored in the frame buffer 2; and frame # (1+2n) may be stored in the frame buffer 3.

Also, a frame stored in the frame buffer 241 may be stored in the frame queue 242. At this time, the frame unit 240 may store a specific frame stored in the frame buffer 241 into the frame queue 242 by mapping the corresponding frame number to a queue index. For example, frame #1, #(1+n), and #(1+2n) stored in the frame buffer #1, #2, and #3 of Chip #1 may be stored in the frame queue #1, #(1+n), and #(1+2n), respectively.

In one embodiment, the frame unit 240 may operate by reading a current draw number, comparing the draw number with frame numbers of frames stored in the frame queue 242, outputting the corresponding frame if the draw number is equal to the frame number, increasing the draw number by 1 when the outputting is successful, and repeating the above process until the frame queue 242 becomes empty.

In other words, the frame unit 240 may output the frames stored in the frame queue 242 to the screen through a draw. At this time, the draw order may be determined by a draw number. Here, the draw number may correspond to an identification number used to determine the draw order. The frame unit 240 may start a draw operation when the draw number is initialized to 1 and may increase the draw number by 1 each time a draw is performed. As a result, the drawing operation performed by the ray tracing system may correspond to an operation of displaying the corresponding frame to the screen when a frame having a frame number matching the draw number is found in the frame queue 242 and waiting if the corresponding frame is absent. Accordingly, the drawing operation may be sequentially performed from frame #1, which may be processed in the same manner as the display order.

In FIG. 5, Chip #1, #2, and #3 generate frames #1, #2, and #3, respectively, after which frame number #4, #5, and #6 obtained by adding the total number of chips may be generated. Each chip (ray tracing core) has three frame buffers, and generated frames may be sequentially stored in the frame buffer. Frames #1, #4, and #7 are stored in frame buffers 1, 2, and 3 of Chip #1; frames #2, #5, and #8 are stored in frame buffers 1, 2, and 3 of Chip #2; and frames #3, #6, and #9 may be stored in frame buffers 1, 2, and 3 of Chip #3.

The frames stored in the frame buffer of each chip may be stored in the frame queue 242 in the same order as the frame number. Frames #1, #4, and #7 stored in frame buffers 1, 2, and 3 of Chip #1 are stored in frame queues 1, 4, and 7, respectively, and the frames stored in frame buffers of Chips #2 and #3 are also stored in the frame queue 242 in the same manner. Frames stored in the frame queue 242 may be sequentially displayed on the screen by the draw operation, and drawing may be sequentially performed from frame queue 1 by comparing draw numbers and frame numbers. At this time, the draw number may be increased by 1 when the drawing is performed.

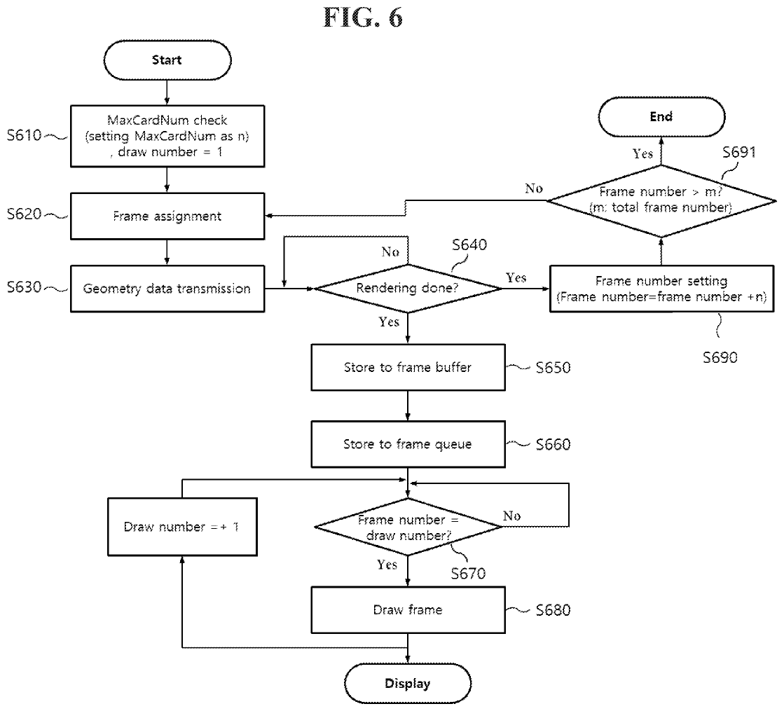

FIG. 6 is a flow diagram illustrating an operational process of a multi-chip ray tracing method using frame partitioning according to the present disclosure.

Referring to FIG. 6, a multi-chip ray tracing method using frame partitioning according to the present disclosure may be performed as follows.

The MaxCardNum check step S610 may check the total number of chips (ray tracing cores) used in the multi-chip (ASIC or FPGA) system and set the draw number to 1.

The frame assignment step S620 may correspond to a step of assigning a frame to be rendered to each chip. When employed chips are #1, #2, and ˜#n, frames #1, #2, and ˜#n may be assigned to the respective chips.

In the geometry data transmission step S630, each chip may receive geometry information on the assigned frames. Afterwards, in the rendering done step S640, rendering may be performed based on the received geometry information. When rendering is completed, the store to frame buffer step S650 of storing a resultant image in a frame buffer and the frame number setting step S690 of setting the frame number of the next frame to be rendered may proceed.

In the store to frame buffer step S650, a rendered frame may be stored in the frame buffer assigned to the corresponding chip. The store to frame queue step S660 stores frames stored in the frame buffer of each chip into the frame queue, where the size of the frame queue may be equal to the total number of frame buffers. When frames are stored in the frame queue, frame numbers may be checked, and frames are stored in the frame queue at the location corresponding to the checked frame numbers. The location of the frame queue in which a frame is to be stored may be determined by a remainder obtained after dividing the frame number by the frame queue size.

In the comparison of frame number and draw number step S670, it may be checked whether the frame number of a frame stored in the frame queue is the same as the draw number. If the two values are not the same, the process waits until the two values become the same; if they are the same, the corresponding frame may be drawn and displayed through the draw frame step S680. When drawing proceeds, the draw number increases by 1, and the process returns to the comparison of frame number and draw number step S670 to check whether the stored frame is the same as the draw number.

The frame number setting step S690 may set a frame number for a frame to be re-assigned to a chip. The frame number may be determined by the total number of chips and calculated by adding the total number of chips to an initially assigned frame number. If Chip #1 is initially assigned frame #1, and the total number of chips is 3, frame numbers may be set to #4, #7, and #10 afterward. If Chip #2 is initially assigned frame #2, frame numbers may be set to #5, #8, and #11 afterward.

The comparison of frame number and m (total frame number) step S691 may compare the frame number set in the frame number setting step S690 with the total number of frames of a scene. If the set frame number is smaller than m, each chip performs rendering of the corresponding frame; if the set frame number is greater than m, rendering of the corresponding scene may terminate.

Although the present disclosure has been described with reference to preferred embodiments given above, it should be understood by those skilled in the art that various modifications and variations of the present disclosure may be made without departing from the technical principles and scope specified by the appended claims below.

### DESCRIPTIONS OF SYMBOLS

| | |
|---|---|
| 100: Multi-chip ray tracing system using | |
| screen partitioning | |
| 110: Central processing unit | 120: System memory |
| 130: Multi-chip | |
| 200: Multi-chip ray tracing system using | |
| frame partitioning | |
| 230: Ray tracing cores | 231: Bus interface unit |
| 232: Tree build unit | 233: Ray tracing unit |
| 240: Frame unit | 241: Frame buffer |
| 242: Frame queue | |

1. A multi-chip based ray tracing device using frame partitioning, the device comprising:
a system memory storing geometry data and an acceleration structure (AS) for scene generation;
a plurality of ray tracing cores performing independent ray tracing for individual frames based on the geometry data and the acceleration structure; and
a central processing unit executing and managing a ray tracing application and a scene manager and delivering the geometry data and the acceleration structure to the plurality of ray tracing cores.

2. The device of claim 1, wherein the system memory includes a primitive static scene (PSS) area storing PSSs, a primitive dynamic scene (PDS) area storing PDS s, and AS areas, each of which stores a static acceleration structure and dynamic acceleration structures.

3. The device of claim 1, wherein each of the plurality of ray tracing cores includes
a bus interface unit processing data transmission and reception;
a tree build unit (TBU) constructing an acceleration structure (AS);
a ray tracing unit (RTU) performing ray tracing based on the AS; and
a local memory temporarily storing the geometry data and the AS for the ray tracing.

4. The device of claim 1, further including a frame unit arranging and outputting frames received from the plurality of ray tracing cores in a predetermined order.

5. The device of claim 4, wherein the frame unit includes a plurality of frame buffers assigned to each of the plurality of ray tracing cores and storing the frames in the order in which the frames are processed; and
a frame queue storing frames received from the plurality of frame buffers according to frame numbers regardless of the processing order.

6. The device of claim 5, wherein each of the plurality of frame buffers has the same size, and the size of the frame queue is determined according to the number and size of frame buffers.

7. The device of claim 5, wherein the frame unit stores a specific frame stored in the frame buffer into the frame queue by mapping the corresponding frame number to a queue index.

8. The device of claim 7, wherein the frame unit operates by
reading a current draw number;
comparing the draw number with frame numbers of frames stored in the frame queue;
if the draw number is equal to the frame number, outputting the corresponding frame;
increasing the draw number by 1 when the outputting is successful; and
repeating the above process until the frame queue becomes empty.

9. A multi-chip based ray tracing method using frame partitioning, the method comprising:
determining a total number of a plurality of ray tracing cores for performing ray tracing on a plurality of frames constituting a specific scene;
assigning the plurality of frames to each of the plurality of ray tracing cores by partitioning the plurality of frames in frame units;
transmitting geometry data of a system memory to each of the plurality of ray tracing cores;
determining whether ray tracing is completed in units of frames for each of the plurality of ray tracing cores;
when a specific ray tracing core completes ray tracing, storing the corresponding frame in the corresponding frame buffer;
storing the corresponding frame in a frame queue; and
outputting frames of the frame queue sequentially.

10. The method of claim 9, wherein the determining of the total number of the plurality of ray tracing cores includes initializing a draw number, and
the outputting includes outputting a frame having the same frame number as a current draw number from the frame queue.

11. The method of claim 10, wherein the outputting includes increasing the current draw number by 1 when the outputting is successful.

12. The method of claim 9, wherein the assigning of the plurality of frames into each of the plurality of ray tracing cores includes assigning a frame number to an assigned frame, wherein the frame number is set for each ray tracing core and set at an interval equal to the total number of frames with respect to a previous frame number.

13. The method of claim 12, wherein, when the frame number is larger than the total number of the plurality of frames, rendering of the specific scene is terminated.
